(19) United States
(12) Patent Application Publication
(10) Pub. No.: US 2005/0171284 A1
(43) Pub. Date: Aug. 4, 2005

(54) Process for producing modified polyolefin resin

(75) Inventors: Shinichi Kondo, Ichihara-shi (JP); Takashi Sanada, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/960,070

(22) Filed: Oct. 8, 2004

(30) Foreign Application Priority Data
Feb. 3, 2004 (JP) 2004-026447

(51) Int. Cl. C08F 8/00

(52) U.S. Cl. 525/192

(57) ABSTRACT

There is provided a process for producing a modified polyolefin resin, which comprises the step of melt-kneading a blend containing: (A) 100 parts by weight of a polyolefin resin, (B) 0.1 to 20 parts by weight of a compound represented by the following formula (1), and
(C) 0.01 to 20 parts by weight of an organic peroxide having a decomposition temperature of 50 to 115° C., at which temperature a half-life thereof is 1 minute, 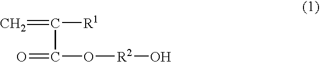
wherein R¹ is a hydrogen atom or an alkyl group having 1 to 6 carbon atoms; and R² is an alkylene group having 1 to 20 carbon atoms.

### FIELD OF THE INVENTION

The present invention relates to a process for producing a modified polyolefin resin.

### BACKGROUND OF THE INVENTION

JP 6-345829A discloses a process for producing a modified propylene-based polymer having excellent coating and adhering properties, which process comprises the step of heating a mixture of a propylene-based polymer, an organic compound containing one or more unsaturated bonds and a hydroxyl group, a styrene-based monomer, and a conventional organic peroxide. Mechanical properties of the modified propylene-based polymer are only a little poorer than those of the propylene-based polymer.

Also, JP 7-173229A discloses a process for producing an unsaturated carboxylic acid-modified polyolefin, which process comprises the step of reacting a polyolefin with an unsaturated carboxylic acid or its derivative, and divinylbenzene. The process can control decomposition of the polyolefin, and can give an increased grafting amount of the unsaturated carboxylic acid or its derivative.

Further, JP 2002-308947A (corresponding to U.S. Pat. No. 6,569,950B2) discloses a process for producing an acid-modified polypropylene resin, which process comprises the step of melt-kneading a blend of a polypropylene resin, an unsaturated carboxylic acid and/or its derivative, and two kinds of organic peroxides having a different decomposition temperature from each other, at which temperature a half-life thereof is 1 minute. The process gives a large grafting amount of the unsaturated carboxylic acid and/or its derivative, and excellent productivity.

### SUMMARY OF THE INVENTION

However, the above-mentioned processes have problems in that (1) a molecular weight of a produced modified polymer is much lower than that of a polymer used as a starting material, (2) a grafting amount is too small, and (3) a coating property (in particular, coating property of a water-soluble coating) is insufficient.

In view of the above problems, an object of the present invention is to provide a process for producing a modified polyolefin resin, (1) whose molecular weight is not much lower than that of a polyolefin resin used as a starting material, (2) whose grafting amount is large, and (3) whose coating property (in particular, coating property of a water-soluble coating) is excellent.

The present inventors have undertaken extensive studies to accomplish the above-mentioned object, and as a result, have found that the above-mentioned object can be accomplished by the present invention, and thereby, the present invention has been obtained.

The present invention is a process for producing a modified polyolefin resin, which comprises the step of melt-kneading a blend containing:
(A) 100 parts by weight of a polyolefin resin,
(B) 0.1 to 20 parts by weight of a compound represented by the following formula (1), and
(C) 0.01 to 20 parts by weight of an organic peroxide having a decomposition temperature of 50 to 115° C., at which temperature a half-life thereof is 1 minute, 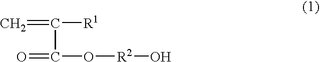
   wherein R¹ is a hydrogen atom or an alkyl group having 1 to 6 carbon atoms; and R² is an alkylene group having 1 to 20 carbon atoms.

The above-mentioned polyolefin resin (A), compound (B) represented by the above formula (1), and organic peroxide (C) having a decomposition temperature of 50 to 115° C., at which temperature a half-life thereof is 1 minute, are referred to hereinafter as “component (A)”, “component (B)” and “component (C)”, respectively.

### DETAILED DESCRIPTION OF THE INVENTION

The component (A) means a resin containing an olefin unit, wherein the term “unit” means a polymerized olefin-monomer unit contained in the resin.

Examples of the component (A) are an ethylene polymer resin, a propylene polymer resin, a butene polymer resin, and a hydrogenated block copolymer resin.

The above-mentioned “ethylene polymer resin” means an ethylene homopolymer; a copolymer containing 51 to 99.99% by weight of an ethylene unit and 49 to 0.01% by weight of a unit of one or more kinds of other monomers copolymerizable with ethylene, wherein the total of both units is 100% by weight; or a combination of two or more thereof.

Examples of the above-mentioned other monomers copolymerizable with ethylene are an α-olefin having 3 to 20 carbon atoms such as propylene, 1-butene, 1-pentne, 1-hexene, 1-octene and 1-decene; an acrylic ester such as methyl acrylate; and vinyl acetate.

Examples of the above-mentioned copolymer in the ethylene polymer resin are an ethylene-α-olefin copolymer such as an ethylene-propylene copolymer, an ethylene-1-butene copolymer, an ethylene-1-pentene copolymer, an ethylene-1-hexene copolymer, an ethylene-1-octene copolymer and an ethylene-1-decene copolymer; an ethylene-acrylic ester copolymer; and an ethylene-vinyl acetate copolymer.

The above-mentioned “propylene polymer resin” means (1) a propylene homopolymer, (2) a random copolymer containing 51 to 99.99% by weight of a propylene unit and 49 to 0.01% by weight of a unit of one or more kinds of other monomers selected from the group consisting of ethylene and an α-olefin having four or more carbon atoms, wherein the total of both units is 100% by weight, (3) an ethylene-propylene block copolymer, which comprises (i) a first polymer containing only a propylene unit and (ii) a second polymer of an ethylene-propylene random copolymer containing 20 to 90% by weight of a propylene unit and 80 to 10% by weight of an ethylene unit, wherein the total of the propylene unit and the ethylene unit is 100% by weight, (4) a propylene-α-olefin block copolymer, which comprises (i) a first polymer containing only a propylene unit and (ii) a second polymer of a propylene-α-olefin random copolymer containing 20 to 90% by weight of a propylene unit and 80 to 10% by weight of a unit of an α-olefin having four or more carbon atoms, wherein the total of the propylene unit and the unit of an α-olefin having four or more carbon atoms is 100% by weight, or (5) a combination of two or more of the above-mentioned polymers (1) to (4).

Examples of the α-olefin in the above-mentioned propylene polymer resin are an α-olefin having 4 to 20 carbon atoms such as 1-butene, 1-pentene, 1-hexene, 1-octene and 1-decene; and a combination of two or more thereof.

Examples of the above-mentioned random copolymer (2) are a propylene-ethylene random copolymer, a propylene-1-butene random copolymer, and a propylene-ethylene-1-butene random copolymer.

Examples of the above-mentioned propylene-α-olefin block copolymer (4) are a propylene-1-butene block copolymer, a propylene-1-pentene block copolymer, and a propylene-1-hexene block copolymer.

The above-mentioned block copolymers (3) and (4), and a production process thereof are well known in the art. An example of the process known in the art comprises the steps of (i) making the above-mentioned first polymer, and (ii) making the above-mentioned second polymer in the presence of the first polymer. The above-mentioned block copolymers (3) and (4) are not, in the strict sense, a block copolymer having a structure such as SS—SSBB—BBSS—SS, wherein SS—SS is a block consisting of a styrene unit of S, and BB—BB is a block consisting of a butadiene unit of B, but substantially a polymer composition comprising the first polymer and the second polymer. The above-mentioned copolymers (3) and (4) are, however, referred to as a block copolymer in the art, respectively, in view of a production process thereof.

The above-mentioned “butene polymer resin” means a butene homopolymer; a copolymer containing 51 to 99.99% by weight of a butene unit and 49 to 0.01% by weight of a unit of one or more kinds of other monomers copolymerizable with butene, wherein the total of both units is 100% by weight; or a combination of two or more thereof.

An example of the above-mentioned butene polymer resin is a homopolymer of 1-butene.

The above-mentioned “hydrogenated block copolymer resin” means a resin having (i) 15 to 85% by weight of a polymer block containing an aromatic vinyl compound unit, and (ii) 85 to 15% by weight of a polymer block containing a conjugated diene compound unit, the total of both units being 100% by weight, wherein 70% or more of a carbon-to-carbon double bond (—C═C—) contained in the polymer block containing a conjugated diene compound unit is hydrogenated.

The above-mentioned polymer block containing an aromatic vinyl compound unit is a polymer block comprising one or more kinds of aromatic vinyl compound units. Examples of the aromatic vinyl compound are styrene, α-methylstyrene, p-ethylstyrene, 2,4-dimethylstyrene, vinylnaphthalene and vinylanthracene. Among them, styrene or α-methylstyrene is preferable, and styrene is more preferable.

The above-mentioned polymer block containing a conjugated diene compound unit is a polymer block comprising one or more kinds of conjugated diene compound units. Examples of the conjugated diene compound are 1,3-butadiene, isoprene, 1,3-pentadiene, 3-butyl-1,3-octadiene and 4-ethyl-1,3-hexadiene. Among them, 1,3-butadiene or isoprene is preferable. Also, the above-mentioned polymer block containing a conjugated diene compound unit is a polymer block comprising (i) one or more kinds of conjugated diene compound units, and (ii) one or more kinds of aromatic vinyl compound units, wherein examples of the conjugated diene compound and aromatic vinyl compound are those mentioned above.

Examples of the alkyl group having 1 to 6 carbon atoms of R¹ in the above formula (1) are a methyl group, an ethyl group, a propyl group and a butyl group. Examples of the alkylene group having 1 to 20 carbon atoms of R² in the above formula (1) are an ethylene group, a propylene group, a butylene group, an amylene group (pentylene group) and a hexylene group.

Examples of the component (B) are 2-hydroxyethyl methacrylate, 2-hydroxyethyl acrylate, 2-hydroxypropyl methacrylate, 2-hydroxypropyl acrylate, 2-hydroxybutyl methacrylate, and 2-hydroxybutyl acrylate.

The component (B) is used in an amount of 0.1 to 20 parts by weight, and preferably 0.5 to 10 parts by weight, per 100 parts by weight of the component (A). When the amount is smaller than 0.1 part by weight, a grafting amount of the component (B) onto the component (A) may be small. When the amount is larger than 20 parts by weight, an obtained modified polyolefin resin may contain a large amount of the component (B) undergoing no reaction, and as a result, the modified polyolefin resin may not have a sufficiently good effect, for example, on wettability of a water-soluble coating material comprising the modified polyolefin resin.

The component (C) has a decomposition temperature of 50 to 115° C., and preferably 7D to 110° C., at which temperature a half-life thereof is 1 minute. The component (C) is preferably an organic peroxide having a function of decomposing to generate a radical, which pulls a proton from the component (A) by a pull reaction. When the decomposition temperature is lower than 50° C., a grafting amount of the component (B) onto the component (A) may be small. When the decomposition temperature is higher than 115° C., a modified polyolefin resin may not be produced stably.

An example of the component (C) is a percarbonate compound having a structure represented by the following formula (2), 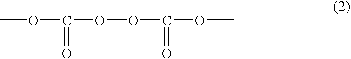
and the percarbonate compound has such a function as mentioned above that it is a preferable organic peroxide.

Examples of the percarbonate compound are dicetyl peroxydicarbonate, di-3-methoxybutyl peroxydicarbonate, di-2-ethylhexyl peroxydicarbonate, bis(4-tert-butylcyclohexyl) peroxydicarbonate, diisopropyl peroxydicarbonate, tert-butyl peroxyisopropylcarbonate and dimyristyl peroxycarbonate.

The component (C) is used in an amount of 0.01 to 20 parts by weight, and preferably 0.05 to 10 parts by weight, per 100 parts by weight of the component (A). When the amount is smaller than 0.01 part by weight, a grafting amount of the component (B) onto the component (A) maybe small. When the amount is larger than 20 parts by weight, decomposition of the component (A) may be promoted.

In order to increase a grafting amount of the component (B) onto the component (A), each of the components (A), (B) and (C) may be combined with an organic peroxide (component (D)) having a decomposition temperature of 150 to 200° C., at which temperature a half-life thereof is 1 minute. In order to further increase a grafting amount of the component (B) onto the component (A), it is preferable to combine any of the components (A), (B) and (C) with an organic peroxide having a decomposition temperature of 160 to 195° C., at which temperature a half-life thereof is 1 minute.

Examples of the component (D) are 1,1-bis(tert-butylperoxy)cyclohexane, 2,2-bis(4,4-di-tert-butylperoxycyclohexyl)propane, 1,1-bis(tert-butylperoxy)cyclododecane, tert-hexylperoxyisopropyl monocarbonate, tert-butylperoxy-3,5,5-trimethyl haxonoate, tert-butylperoxylaurate, 2,5-dimethyl-2,5-di(bezoylperoxy)hexane, tert-butylperoxyacetate, 2,2-bis(tert-butylperoxy)butene, tert-butylperoxybenzoate, n-butyl-4,4-bis(tert-butylperoxy)valerate, di-tert-butylperoxyisophthalate, dicumylperoxide, α-α′-bis(tert-butylperoxy-m-isopropyl)benzene, 2,5-dimethyl-2,5-di(tert-butylperoxy)hexane, 1,3-bis(tert-butylperoxyisopropyl)benzene, tert-butylcumylperoxide, di-tert-butylperoxide, p-menthane hydroperoxide and 2,5-dimethyl-2,5-di(tert-butylperoxy)hexyne-3.

The component (D) is used in an amount of preferably 0.01 to 20 parts by weight, and more preferably 0.01 to 1.0 part by weight, per 100 parts by weight of the component (A). When the amount is larger than 20 parts by weight, decomposition of the component (A) may be promoted.

Each of the components (A), (B) and (C) may be combined with an electron donor compound such as styrene and divinylbenzene, or with an additive known in the art and conventionally used in combination with a polyolefin resin, such as an antioxidant, a heat stabilizer, and a neutralizer.

A method for obtaining a blend containing the components (A), (B) and (C) in the present invention may be a method known in the art. A preferable method comprises (1) the step of mixing the total of the components (A), (B) and (C) in a lump, or (2) the steps of (i) mixing separately two or more combinations containing those components to obtain two or more mixed combinations, and then (ii) further mixing the two or more mixed combinations in a lump, with an apparatus such as a Henschel mixer, a ribbon blender, and a blender.

An example of a melt-kneading method in the present invention is a method using an apparatus known in the art such as a Banbury mixer, a plastomil, a Brabender plastograph, a single-screw extruder and a twin-screw extruder. Among them, it is particularly preferable to melt-knead a blend containing the components (A), (B) and (C) in a single-screw extruder or a twin-screw extruder by feeding the blend to an inlet of the single-screw extruder or the twin-screw extruder, in view of continuous production (namely, productivity).

A temperature in a melt-kneading zone of a melt-kneading apparatus such as a cylinder temperature in an extruder is generally 50 to 300° C., and preferably 100 to 250° C. in order to increase a grafting amount of the component (B) onto the component (A), and in order to control decomposition of the component (A).

In the present invention, it is preferable to carry out the melt-kneading in two stages, and a melt-kneading temperature in the second stage is preferably higher than that in the first stage. Namely, when an extruder is used as a melt-kneading apparatus, it is preferable to divide its melt-kneading zone into the first melt-kneading zone as the first stage, and the second melt-kneading zone as the second stage. A temperature in the second melt-kneading zone is preferably higher than that in the first melt-kneading zone; and the temperature in the first melt-kneading zone is preferably 50 to 200° C., and the temperature in the second melt-kneading zone is preferably 150 to 300° C.

A melt-kneading period of time is generally 0.1 to 30 minutes, and particularly preferably 0.5 to 5 minutes in order to increase a grafting amount of the component (B) onto the component (A), and in order to control decomposition of the component (A).

Since the modified polyolefin resin produced by the process in accordance with the present invention has a large grafting amount, it is excellent in its coating property (in particular, coating property of a water-soluble coating). Therefore, the modified polyolefin resin is suitably used in combination with a polyolefin resin to produce a resin composition, which can be used for producing an interior or exterior part of an automobile such as an instrumental panel, a pillar, and a bumper.

### EXAMPLE

The present invention is explained with reference to the following Examples, which do not limit the scope of the present invention.

### Example 1

To 100 parts by weight of a propylene homopolymer (A-1) having a melt index of 0.5 g/10 minutes measured at 230° C. under a load of 21.1 N according to Japanese Industrial Standards (JIS) K7210, there were added (1) 3.0 parts by weight of 2-hydroxyethyl methacrylate (B-1), (2) 0.50 part by weight of dicetyl peroxydicarbonate (C) containing 2.8% of an active oxygen, and having a decomposition temperature of 99° C., at which temperature a half thereof is 1 minute, (3) 0.15 part by weight of 1,3-bis(tert-butylperoxyisopropyl)benzene (D) containing 9.3% of an active oxygen, and having a decomposition temperature of 183° C., at which temperature a half thereof is 1 minute, (4) 0.05 part by weight of calcium stearate, (5) 0.3 part by weight of tetrakis[methylene-3-(3,5-di-tert-butyl-4-hydroxyphenyl) propionate]methane (antioxidant), and (6) 3.0 parts by weight of styrene (E), and then, the obtained mixture was blended sufficiently, thereby obtaining a blend.

The blend was melt-kneaded in a twin-screw extruder (L/D=25, and a cylinder diameter=20 mm) having a trade name of 2D25-S manufactured by Toyo Seiki Co., Ltd., wherein a temperature in its first melt-kneading zone was 180° C., and a temperature in its second melt kneading zone was 260° C., and its screw rotating speed was 70 rpm, thereby obtaining a modified polyolefin resin having a melt index of 0.2 g/10 minutes measured according to the same method as that mentioned above.

The modified polyolefin resin had a grafting amount of 0.57% by weight, wherein the total amount of the modified polyolefin resin was 100% by weight, measured by a method comprising the steps of:
(1) dissolving 1.0 g of the modified polyolefin resin in 10 ml of xylene to obtain a solution,
(2) dropping the solution into 300 ml of methanol under stirring to re-precipitate the modified polyolefin resin,
(3) separating the re-precipitated modified polyolefin resin by filtration,
(4) drying the separated modified polyolefin resin in a vacuum drier at 80° C. for 8 hours,
(5) hot-pressing the dried modified polyolefin resin to obtain a film having 100 μm-thickness,
(6) measuring an infrared absorption spectrum of the film, and
(7) determining the grafting amount from the absorption near 1730 cm⁻¹ of the spectrum.

The modified polyolefin resin had a contact angle of 860 measured by a method comprising the steps of:
(1) press-molding the modified polyolefin resin at 230% to obtain a molded article,
(2) dropping 0.4 ml of ion-exchange water on the molded article, and
(3) after 30 seconds from completion of the above step (2), measuring a contact angle with a boundary tension measure.

The contact angle shows wettability, which is an index of a coating property, wherein the smaller the contact angle is, the better the coating property (wettability) is.

Results are summarized in Table 1.

### Example 2

Example 1 was repeated except that the propylene homopolymer (A-1) was changed to an ethylene-propylene block copolymer (A-2) (i) having a melt index of 0.4 g/10 minutes, and (ii) comprising a first polymer containing only a propylene unit, and a second polymer containing 36% by weight of a propylene unit and 64% by weight of an ethylene unit (wherein the total of both units is 100% by weight), thereby obtaining a modified polyolefin resin. Results regarding the modified polyolefin resin are summarized in Table 1.

### Example 3

Example 1 was repeated except that (1) the propylene homopolymer (A-1) was changed to the ethylene-propylene block copolymer (A-2), and (2) 2-hydroxyethyl methacrylate (B-1) was changed to 2-hydroxyethyl acrylate (B-2), thereby obtaining a modified polyolefin resin. Results regarding the modified polyolefin resin are summarized in Table 1.

### Example 4

Example 1 was repeated except that (1) the propylene homopolymer (A-1) was changed to the ethylene-propylene block copolymer (A-2), and (2) 2-hydroxyethyl methacrylate (B-1) was changed to 2-hydroxypropyl methacrylate (B-3), thereby obtaining a modified polyolefin resin. Results regarding the modified polyolefin resin are summarized in Table 1.

### Example 5

Example 1 was repeated except that (1) the propylene homopolymer (A-1) was changed to the ethylene-propylene block copolymer (A-2), and (2) 2-hydroxyethyl methacrylate (B-1) was changed to 2-hydroxypropyl acrylate (B-4), thereby obtaining a modified polyolefin resin. Results regarding the modified polyolefin resin are summarized in Table 1.

### Example 6

Example 1 was repeated except that (1) the propylene homopolymer (A-1) was changed to the ethylene-propylene block copolymer (A-2), and (2) 2-hydroxyethyl methacrylate (B-1) was changed to 2-hydroxybutyl methacrylate (B-5), thereby obtaining a modified polyolefin resin. Results regarding the modified polyolefin resin are summarized in Table 1.

### Example 7

Example 1 was repeated except that (1) the propylene homopolymer (A-1) was changed to the ethylene-propylene block copolymer (A-2), and (2) 2-hydroxyethyl methacrylate (B-1) was changed to 2-hydroxybutyl acrylate (B-6), thereby obtaining a modified polyolefin resin. Results regarding the modified polyolefin resin are summarized in Table 1.

### Comparative Example 1

Example 1 was repeated except that dicetyl peroxydicarbonate (C) was not used. Results are summarized in Table 1.

### Comparative Example 2

A contact angle of the propylene homopolymer (A-1) was measured according to the same method as that mentioned above. Results are summarized in Table 1.

### Comparative Example 3

A contact angle of the ethylene-propylene block copolymer (A-2) was measured according to the same method as that mentioned above. Results are summarized in Table 1.

Table 1 shows that the present invention provides a process for producing a modified polyolefin resin, (1) whose molecular weight is not much lower than that of a polyolefin resin used as a starting material, (2) whose grafting amount is large, and (3) whose coating property (in particular, coating property of a water-soluble coating) is excellent.

TABLE 1

| | Example | | | | | | | Comparative Example | | |
|---|---|---|---|---|---|---|---|---|---|---|
| | 1 | 2 | 3 | 4 | 5 | 6 | 7 | 1 | 2 | 3 |
| Blending ratio (part by weight) | | | | | | | | | | |
| Component (A) | | | | | | | | | | |
| A-1 | 100 | | | | | | | 100 | 100 | |
| A-2 | | 100 | 100 | 100 | 100 | 100 | 100 | | | 100 |
| Component (B) | | | | | | | | | | |
| B-1 | 3.0 | 3.0 | | | | | | 3.0 | | |
| B-2 | | | 3.0 | | | | | | | |
| B-3 | | | | 3.0 | | | | | | |
| B-4 | | | | | 3.0 | | | | | |
| B-5 | | | | | | 3.0 | | | | |
| B-6 | | | | | | | 3.0 | | | |
| Component (C) | 0.50 | 0.50 | 0.50 | 0.50 | 0.50 | 0.50 | 0.50 | | | |
| Component (D) | 0.15 | 0.15 | 0.15 | 0.15 | 0.15 | 0.15 | 0.15 | 0.15 | | |
| Component (E) | 3.0 | 3.0 | 3.0 | 3.0 | 3.0 | 3.0 | 3.0 | 3.0 | | |
| Evaluation of product | | | | | | | | | | |
| Melt index (g/10 minutes) | 0.2 | 0.2 | 0.1 | 0.2 | 0.1 | 0.3 | 0.2 | 2.6 | 0.5 | 0.4 |
| Grafting amount (% by weight) | 0.57 | 1.02 | 1.35 | 0.49 | 0.65 | 0.41 | 0.57 | 0.21 | | |
| Contact angle (°) | 86 | 83 | | | | | | | 88 | 88 |

1. A process for producing a modified polyolefin resin, which comprises the step of melt-kneading a blend containing:
(A) 100 parts by weight of a polyolefin resin,
(B) 0.1 to 20 parts by weight of a compound represented by the following formula (1), and
(C) 0.01 to 20 parts by weight of an organic peroxide having a decomposition temperature of 50 to 115%, at which temperature a half-life thereof is 1 minute, 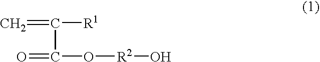
wherein R¹ is a hydrogen atom or an alkyl group having 1 to 6 carbon atoms; and R² is an alkylene group having 1 to 20 carbon atoms.

2. The process for producing a modified polyolefin resin according to claim 1, wherein the organic peroxide (C) has a structure represented by the following formula (2),

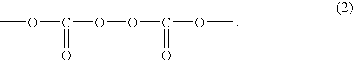

3. The process for producing a modified polyolefin resin according to claim 1, wherein the melt-kneading is carried out in the first stage having a melt-kneading temperature of 50 to 200° C., and then in the second stage having a higher melt-kneading temperature of 150 to 300° C. than the former melt-kneading temperature.
